(19) United States
(12) Patent Application Publication
(10) Pub. No.: US 2009/0074027 A1
(43) Pub. Date: Mar. 19, 2009

(54) HEAT FLUX SENSOR INCORPORATING LIGHT CONVEYANCE

(75) Inventor: Lawrence W. LANGLEY, Blacksburg, VA (US)

Correspondence Address: MORGAN & FINNEGAN, L.L.P., 3 WORLD FINANCIAL CENTER, NEW YORK, NY, 10281-2101, US

(73) Assignee: VATELL CORPORATION, Christiansburg, VA (US)

(21) Appl. No.: 11/857,176

(22) Filed: Sep. 18, 2007

(51) Int. Cl. G01K 17/00

(52) U.S. Cl. 374/29; 374/E17.001

(57) ABSTRACT

A device that may utilize radiant energy emitted from a process to formulate heat flux information about the process. The light emitted from the process may be transmitted by a low loss light conveyance component to a heat flux sensing component situated remotely from the process. The process light energy may then be converted into heat energy by a high emissivity material coupled to the heat flux sensing component. The light conveyance component may further include an angular sensitivity corrector to increase the efficiency of light absorption.

### BACKGROUND OF INVENTION

1. Field of Invention

The present invention relates to measuring heat flux, and more specifically, to a device that may derive heat flux information remotely using a light conveyance component.

2. Background

In general terms, a basic process control model may utilize information fed back from an active process to determine if any changes are needed to bring the process into a desired operating state. For example, a process controller tasked with maintaining the temperature of a process may require some sort of information about thermal energy flow in the process in order to manage operation. Some process control examples may include thermostats for maintaining the temperature in an enclosure (e.g., refrigerator), vehicle, domicile, office, etc.

Over and above these basic examples, energy flow information may also be utilized as feedback data in order to control other aspects of a process. An example of such a process is now described with respect to FIG. 1.

Worldwide concern over natural resource availability has focused attention on emerging technologies that may be utilized to conserve natural resources. FIG. 1A describes an exemplary process for converting solar energy into electrical energy. Solar energy from source 100 (e.g., the sun) may be concentrated by reflector 102 onto conduit 104. Conduit 104 may contain a liquid (e.g., oil, water, etc.) that is heated by the concentrated solar energy. As a result, the liquid may be directly converted to steam, or alternatively, heated liquid may be circulated in a closed loop that transfers the stored heat to a water boiler, which may in turn produce steam used to power turbine 106. Turbine 106 may generate electrical energy 108 for consumption (e.g., the electrical energy may be conveyed to an electrical grid) and the cooled liquid (e.g., after expending its stored heat energy) may then be circulated back to the heat concentration apparatus, as shown at 110, to continue the power generation process. In order for the solar power process to operate at optimum efficiency, many variables must be controlled. For example, the radiant energy focused by reflector 102 on conduit 104 must be monitored in order to control process conditions such as the position of reflector 102, the speed at which the liquid in conduit 104 is circulated, etc. Energy flow monitoring in this case requires a sensing device that can deliver fast and accurate response while being tolerant of adverse operating conditions.

An energy flow sensing device that is able to deliver fast and accurate information while operating in a harsh environment is also required in the example of FIG. 1B. Combustion engines are used today in a multitude of different applications. Burning fuel expanding in a confined space may be used to create force for pushing a piston (e.g., where mechanical energy is required), or it may be used directly for propelling a vehicle, as in the case of a jet engine. In lean stoichiometry combustion engines, fuel may be mixed with an excess of air in order to create combustion at a lower temperature that uses less fuel. In FIG. 1B, a combustion chamber 120 may receive airflow 122 which may be disrupted by specific configurations of bluff objects (e.g., compressor blades 124). Modified airflow 122 may then pass by fuel injectors 126 so that airflow 122 and fuel flow 128 may be combined before being ignited at 130. A problem endemic to this process is that the location of combustion 130, as shown within the dotted region 132, tends not to remain in the optimum combustion zone labeled “B” on range 134. The burning fuel and air tend to drift into the “A” and “C” regions also shown at 134. If the primary combustion zone stays near the “B” zone, then the process may be optimized. However, combustion in the “A” and/or “C” regions may result in reduced engine efficiency, or may even damage engine components. The location of combustion zone 132 may be determined through the use of radiant energy sensing devices. However, this exemplary application would require a device that is sensitive to minute changes in the measured variable, responds quickly and is able to withstand a high temperature environment.

### SUMMARY OF INVENTION

The present invention, in at least one embodiment, is directed to a device for monitoring a process in order to formulate heat flux information. The device may include a heat flux sensing component situated remotely from the actual process, which may receive radiant energy emitted from the process via a light conveyance component. The radiant energy emitted from the process may be converted into heat energy by a material thermally coupled to the heat flux sensing component, which formulates process heat flux information based on the induced heat. The light conveyance component may further include an angular sensitivity corrector.

An exemplary implementation of the present invention may include a heat flux microsensor (HFM) configured to measure radiant heat energy impinging upon a high emissivity material. The high emissivity material, having high light-to-heat conversion efficiency, may be thermally coupled to a sensing surface on the HFM. The sensing surface, including the high-emissivity material, may further be positioned in a device housing so that it is adjacent to an end of the light conveyance component. More specifically, the device housing may consist of one or more components which, when coupled together, form a gap within the housing bordered on one side by the sensing surface of the heat flux sensor and on the opposite side by an output end of the light conveyance component.

The light conveyance component, in accordance with various embodiments of the present invention, may include a rigid and/or flexible light conductor. A rigid light conductor, such as a light pipe, may be a substantially cylindrical optically transparent rod configured to convey radiant energy emitted by a process to a remotely located heat flux sensing component. A flexible light conductor, such as a fiber optics, may include one or more (e.g., bundled) optical fibers oriented in a configuration similar to the light pipe. The light conveyance component may include an input end and an output end, the output end being coupled to at least one device housing component as previously disclosed. The input end of the light conveyance component may include an angular sensitivity corrector for tailoring the acceptance angles for receiving radiant energy. The angular sensitivity corrector may be configured on the input end of the light conveyance component in order to influence the absorption of radiant energy emitted from a process into the light conveyance component, and may alternatively comprise a curved surface formed on, or attached to, the input end of the light conveyance component.

### DESCRIPTION OF DRAWINGS

The invention will be further understood from the following detailed description of various exemplary embodiments, taken in conjunction with appended drawings, in which:

FIG. 1A discloses an exemplary process in which at least one embodiment of the present invention may be implemented.

FIG. 1B discloses another exemplary process in which at least one embodiment of the present invention may be implemented.

FIG. 2A discloses a perspective view of an exemplary device in accordance with at least one embodiment of the present invention.

FIG. 2B discloses a perspective view of an exemplary device in an alternative configuration in accordance with at least one embodiment of the present invention.

FIG. 3A discloses a structural configuration of a device in accordance with at least one embodiment of the present invention.

FIG. 3B discloses an alternative structural configuration of a device in accordance with at least one embodiment of the present invention.

FIG. 4A discloses an exemplary device, in accordance with at least one embodiment of the present invention, being applied to monitor a process.

FIG. 4B discloses an exemplary configuration of an angular sensitivity corrector in accordance with at least one embodiment of the present invention.

FIG. 4C discloses an alternative exemplary configuration of an angular sensitivity corrector in accordance with at least one embodiment of the present invention.

FIG. 4D discloses a second alternative exemplary configuration of an angular sensitivity corrector in accordance with at least one embodiment of the present invention.

FIG. 4E discloses a third alternative exemplary configuration of an angular sensitivity corrector in accordance with at least one embodiment of the present invention.

FIG. 4F discloses an exemplary configuration in accordance with at least one embodiment of the present invention wherein a separate angular sensitivity corrector may be coupled to the light pipe.

FIG. 4G discloses an alternative exemplary configuration in accordance with at least one embodiment of the present invention wherein a separate angular sensitivity corrector may be coupled to the light pipe.

FIG. 5 discloses a structural view of an exemplary heat flux microsensor usable with at least one embodiment of the present invention.

FIG. 6 discloses an image of a sensing surface from an exemplary heat flux microsensor (HFM) usable with at least one embodiment of the present invention.

### DESCRIPTION OF EXEMPLARY EMBODIMENTS

While the invention has been described below in a multitude of exemplary embodiments, various changes can be made therein without departing from the spirit and scope of the invention, as described in the appended claims.

### I. Exemplary Device

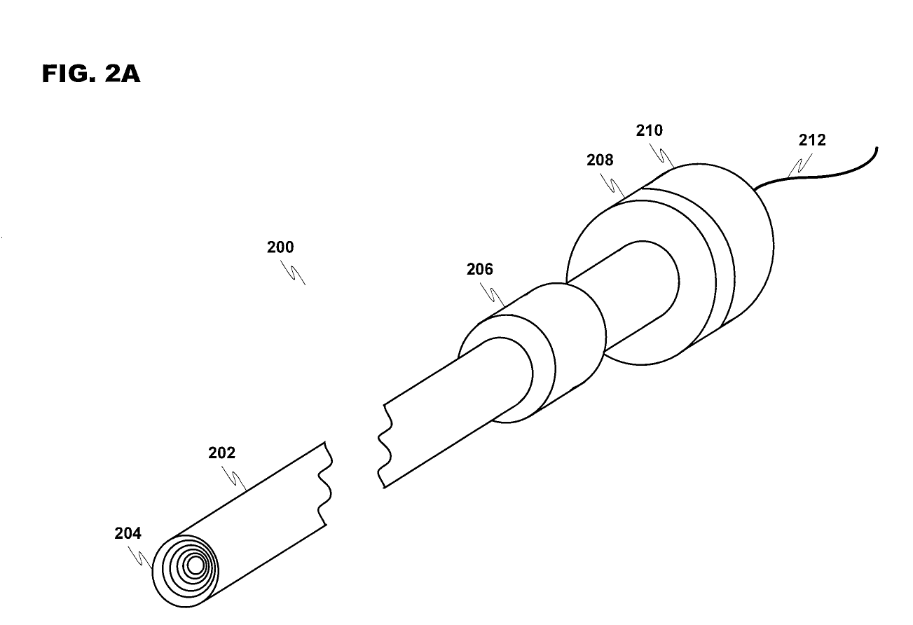

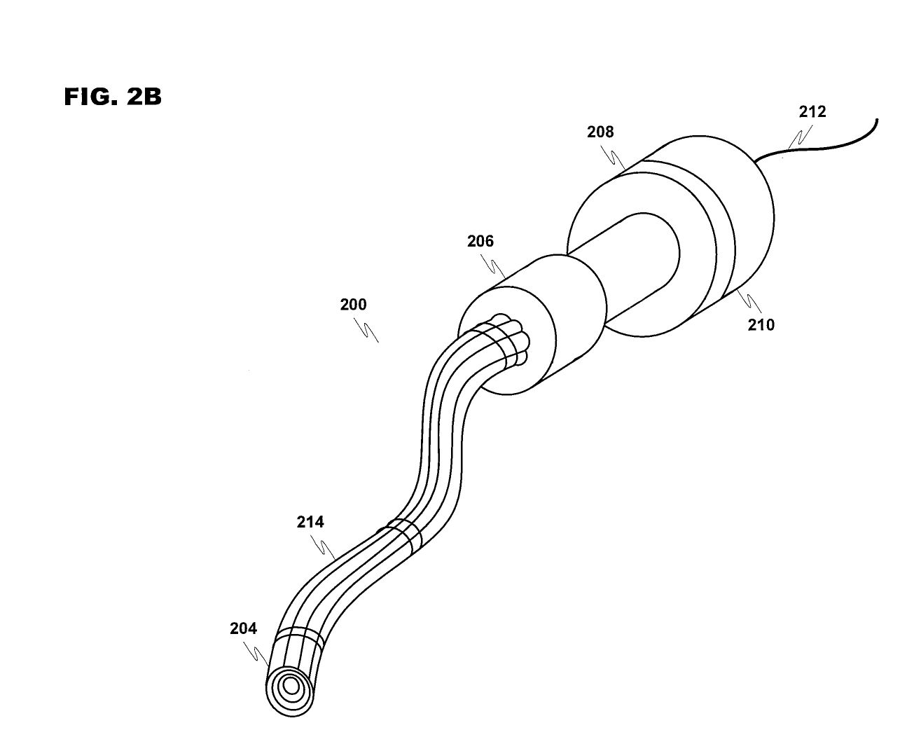

Now referring to FIG. 2A, a perspective view of sensor device 200 in accordance with at least one embodiment of the present invention is disclosed. Sensor device 200 may be employed to obtain heat flux information from a process utilizing a sensing component situated remotely from the process. This remote sensing functionality may be achieved by conveying radiant energy emitted from the process through light pipe 202 to a sensor device. Light pipe 202 may be a substantially cylindrical light pipe constructed from a high light transmittance (and therefore low light loss) material such as sapphire. For example, an optical grade sapphire light pipe with a 4 millimeter diameter and 250 millimeter length usable in at least one embodiment of the present invention may transmit light at 83% efficiency across most of the sapphire range. The use of sapphire may also provide additional durability for utilization in harsh environments.

Alternatively, light pipe 202 may also comprise other high light transmittance materials such as silica or low loss optical glass. The diameter and length of light pipe 202, as well as the dimensions of heat flux sensing component 300, may be selected to convey all or only part of the radiative energy received from the process to heat flux sensing component 300. Further, while the disclosed exemplary embodiments of the present invention show light pipe 202 in a linear configuration, light pipe 202 may also be curved over some or all of its length in order to fit into a particular process space. A curved light pipe 202 may, for example, be more appropriate for use in applications that require resistance to harsh conditions in a confined area.

Light pipe 202 is shown “broken” in FIG. 2A to illustrate that it may vary in length depending on the practical application, and may include at least an input end and an output end. In the exemplary configuration of FIG. 2A, the input end may further include angular sensitivity corrector 204 for influencing the effect of incidence angle in its collection of radiant energy. The output end of light pipe 202 may be inserted into the housing of sensor device 200 through first housing component 206, which may further be coupled to second housing component 208. In at least one embodiment of the present invention, housing component 208 may also be coupled to temperature control component 210. Sensor device 200, when operational, may obtain heat flux information from a process and transmit this information to another device, such as a process controller, via a communicative coupling such as cable 212.

FIG. 2B discloses an alternate configuration of sensor device 200 in accordance with at least one embodiment of the present invention. In this example, light pipe 202 has been replaced with a fiber optics 214. Fiber optics 214 may comprise one or more high transmittance optical fibers. In a configuration where a plurality of optical fibers exist, these cables may be bundled together to work cooperatively in a similar manner as disclosed above with respect to light pipe 202. Further, fiber optics 214 may include an input end and output end, the input end including at least light sensitivity corrector 204. As set forth above, the output end may be coupled to, or inserted in, first housing component 206. The use of light pipe 202 and/or fiber optics 214 may be determined by the monitored process. For example, a particularly harsh or caustic process may require a more durable light conveyance component like light pipe 202, however, fiber optic 214 may be more useful where the a process chamber is hard to access, and therefore, requires flexibility. Further, the two light conveyance components may also be used together with appropriate optic coupling so that light loss does not occur where they are joined.

### II. Exemplary Structural Configuration

For the sake of explanation in the following disclosure, sensing device 200 is described only using light pipe 202. However, the present invention is not limited to this specific embodiment, and may use one or both of the previously described light conveyance components.

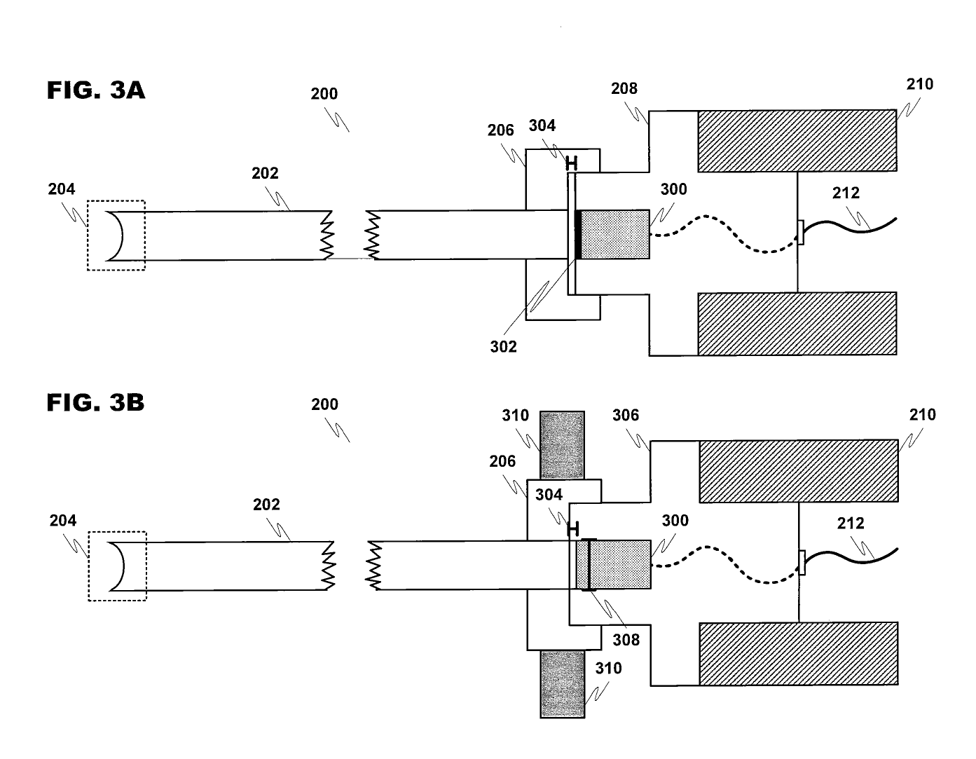

An exemplary structural representation of sensor device 200, in accordance with at least one embodiment of the present invention, is now disclosed in FIG. 3A. As in FIG. 2A, light pipe 202 is again represented as “broken” to illustrate that the length of light pipe 202 may vary depending on the particulars of the monitored process. Light pipe 202 may further include at least an input end and an output end, wherein an angular sensitivity corrector located on the input end of light pipe 202 is highlighted at 204. The output end of light pipe 202 may be inserted into a device housing. While light pipe 202 has been shown as surrounded by first housing component 206, the present invention may include a unified device housing or multiple housing components depending on various process requirements, device configurations, etc. The coupling between light pipe 202 and first housing component 206 may be maintained using adhesive, mechanical fittings, frictional engagement, etc. as long as the optical properties of light pipe 202 are not compromised by this coupling.

In the disclosed example including a multiple component device housing, the combined light pipe 202 and first housing component 206 assembly may be coupled to second housing component 208. As shown in FIG. 3A, the housing components may be coupled together in an overlapping relationship, wherein first housing component 206 overlaps the second housing component 208. However, the disclosed overlapping relationship is not necessary as long as the output end of light pipe 202 is arranged adjacent to a sensing surface of heat flux sensing component 300. In this arrangement, light pipe 202 may deliver light collected from a monitored process through angular sensitivity corrector 204 to a high emissivity material 302 that is coupled to a sensing surface of heat flux sensing component 300. A high emissivity material is a material that can convert radiant energy to heat energy with high efficiency. For example, black paint may be utilized to cover the sensing surface of heat flux sensing component 300. The temperature induced in high emissivity material 302 by impinging radiant energy from the monitored process may in turn be used to formulate heat flux information for the process.

The configuration shown in FIG. 3A further includes a gap 304 between the output end of light pipe 202 and the high emissivity material 302 covering sensing surface of heat flux sensing component 300. This intentional space may help to protect against errors that might be produced through thermal contact between light pipe 202 and first housing component 206. The dimensions of gap 304 may depend on the nature of the process to which sensor device 200 is applied. For example, if light pipe 202 is monitoring an extremely high temperature region of a process, a greater gap 304 may be necessary to properly insulate heat flux sensing component 300 from any induced temperature errors. This insulating gap may alternatively be evacuated, or may contain air under pressure, an inert gas, etc. as dictated by the process being monitored, device components, etc.

Second housing component 208 may also be coupled to temperature control component 210. Temperature control component 210 may passively and/or actively maintain the temperature of second housing component 208. For example, temperature control component 210 may comprise thermal insulation coupled to second housing component 208 to protect heat flux sensing component 300 from the influence of ambient temperature. However, temperature control component 210 may also employ active temperature control measures such as circulated liquid cooling, fans and/or electronic peltier devices, etc. Cable 212 may pass through secondary housing component 208 in order to electronically couple heat flux sensing component 300 to another device, such as a process controller, so that heat flux information formulated by sensor device 200 may be utilized in controlling the process. While a wired connection 212 has been disclosed in the accompanying figures for the purpose of explaining the conveyance of process heat flux information from sensor device 200, other methods for conveying information such as via wireless or optical communication, while not pictured, may also be used in accordance with various embodiments of the present invention.

FIG. 3B discloses an exemplary structural representation similar to FIG. 3A. However, the exemplary configuration disclosed in FIG. 3B utilizes a different secondary housing component 306, a heat flux sensing component 300 that does not require a high emissivity coating 302, and may further include an additional temperature control component 310 coupled to first housing component 206. In accordance with at least one embodiment of the present invention, the altered second housing component 306 extends further into first housing component 206 when coupled, and as a result, may narrow gap 304 radially (as indicated at 308). This narrowed gap may provide a benefit because a greater concentration of radiant energy conveyed by light pipe 202 may be delivered directly to the sensing surface of heat flux sensing component 300. More specifically, this exemplary configuration of the present invention utilizes a heat flux sensing component 300 that may directly receive radiant energy emitted from the process to formulate process heat flux information without requiring high emissivity coating 302.

While a greater radiant energy concentration may be realized on the sensing surface of heat flux sensor 300, the configuration of FIG. 3B may also provide more material contact between the first and second housing components 206 and 208, respectively, and as a result, more thermal conduction. As a result, an additional temperature control component 310 may be coupled to first housing component 206 to provide greater control over temperatures that may be induced in light pipe 202 and first housing component 206. In this example, temperature control component 310 is disclosed as heat-dissipating fins or sinks, but as stated above in regard to temperature control component 210, additional temperature control component 310 may also incorporate passive and/or active temperature control measures in order to maintain temperature.

It is important to note that the various individual elements and features described with respect to FIG. 3A-3B above may be selectively utilized depending on the requirements of a particular application to which the present invention is being applied, and therefore, the present invention is no way particularly limited to the specific configurations disclosed in FIG. 3A-3B.

### III. Exemplary Angular Sensitivity Correctors for Tailoring Angular Sensitivity

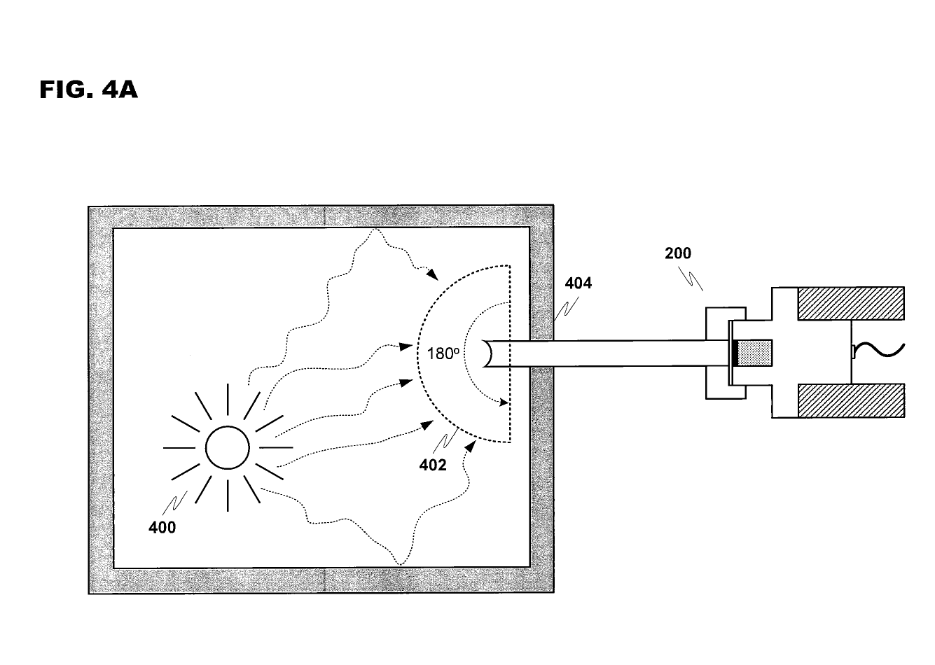

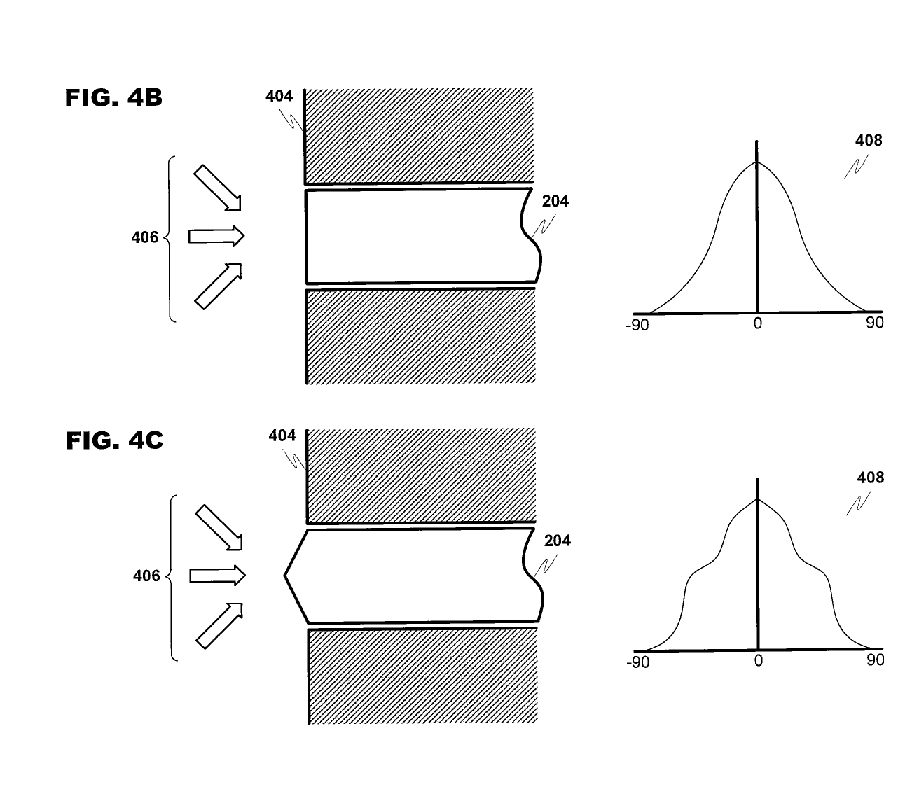

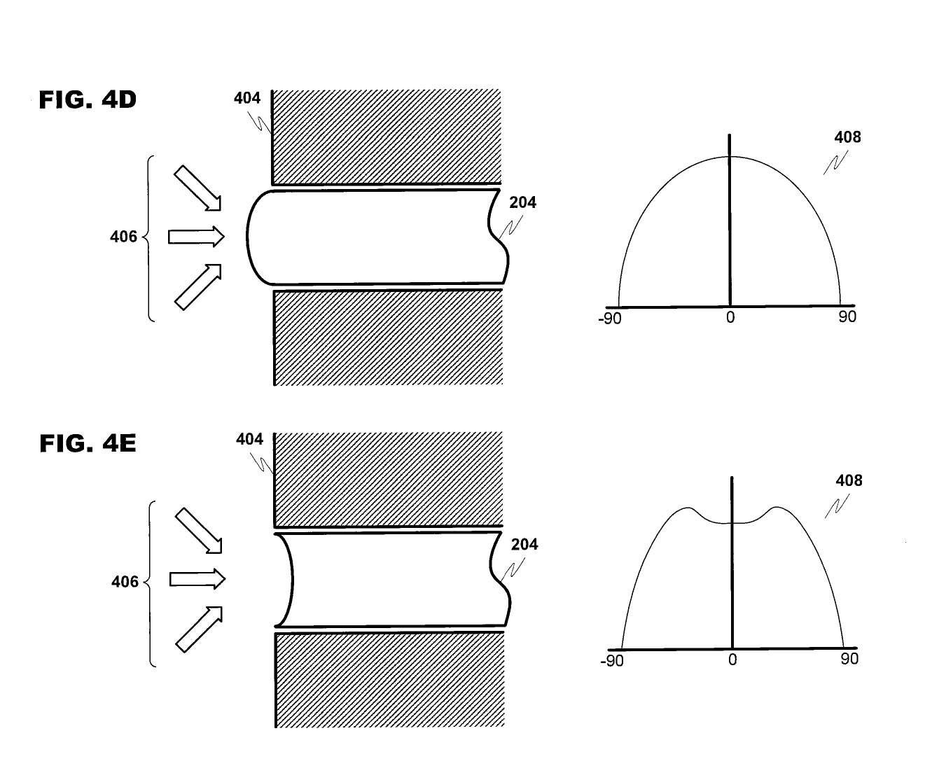

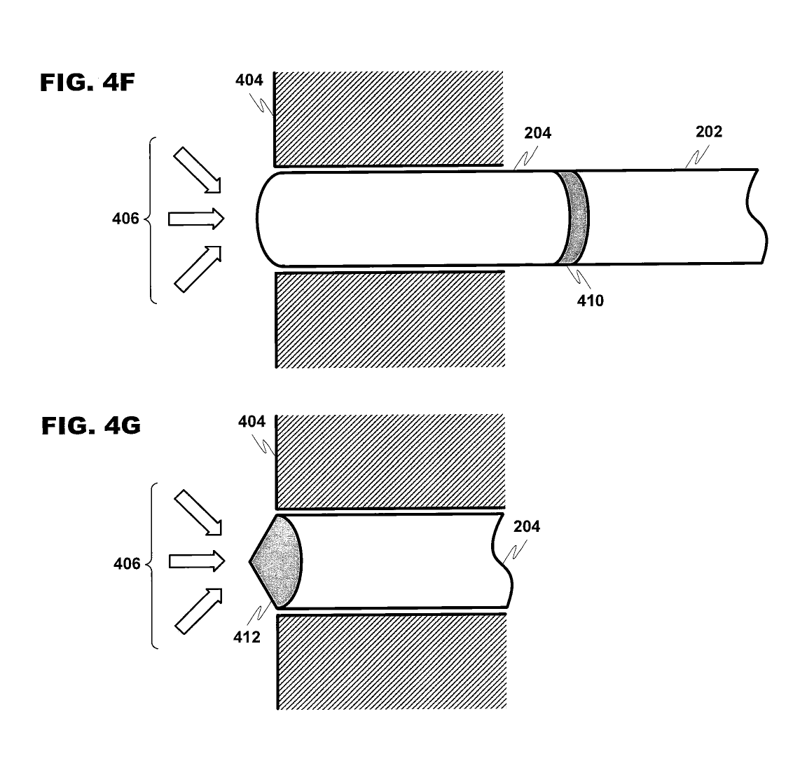

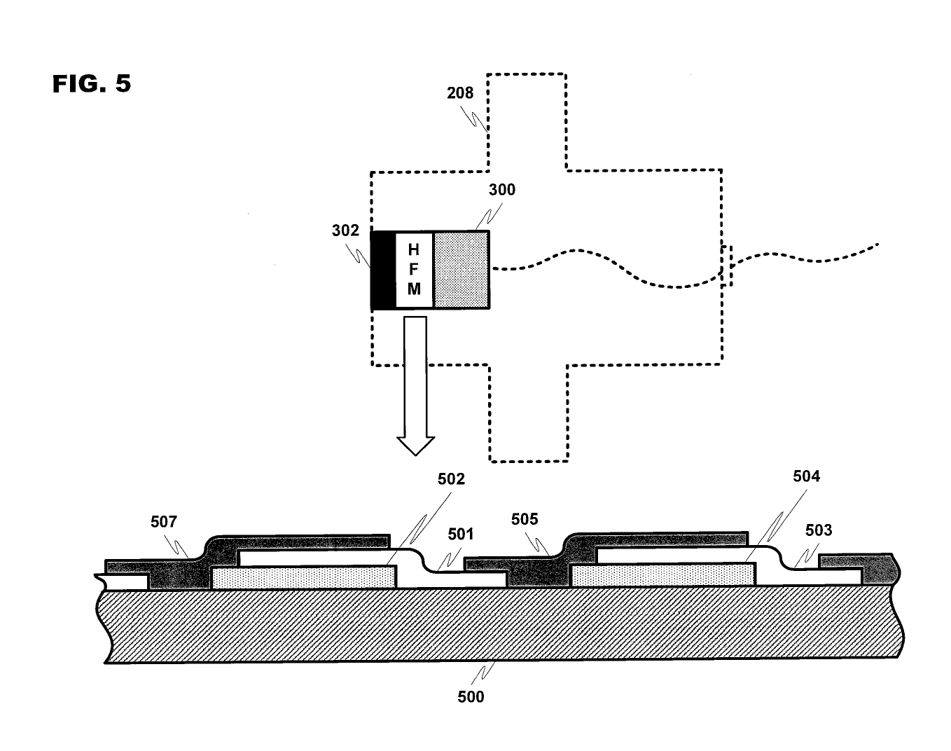

FIG. 4A discloses an exemplary application of sensor device 200 to monitoring a process. The process, represented by 400, may emit radiant energy as a direct process output or as a process by-product. Light pipe 202 may extend into a process chamber through process chamber wall 404 in order to collect radiant energy emitted by the process. As shown in FIG. 4A, the radiant energy emitted by process 400 may not arrive at the input end of light pipe 202 in a path normal to the face of the input end of light pipe 202. The spatial relationship of light pipe 202 to the part of the process emitting radiant energy (e.g., 400), the size of the process chamber, obstructing objects in the process chamber that may cause energy to be blocked, reflected or absorbed, etc. may change the paths for radiant energy emitted by process 400. As a result, the input end of light pipe 202 must be configurable to receive radiant energy over different angles of incidence within the 180° half plane (shown at 402). In this way, the distribution of radiant energy absorbed by the input end of light pipe 202 may be tailored to approximately equal the angular sensitivity of a heat flux sensing component or other radiant energy measuring device.

FIGS. 4B-4G disclose configurations for exemplary angular sensitivity correctors 204 usable with various embodiments of the present invention. The accuracy of the information delivered by heat flux sensing component 300 will be dependent upon the amount and distribution of radiant energy conveyed by light pipe 202 to this component. Therefore, the input end of light pipe 202, when protruding into a process cavity, should absorb energy in accordance with a predetermined functional relationship between the angular sensitivity of the input end and the incidence angle of radiant energy emitted by the process (as shown at 402 in FIG. 4A). To provide this predetermined angular sensitivity, angular sensitivity corrector 204 may impart a particular shape to the input end of light pipe 202. The particular shape may affect the amount of light absorbed by the end of light pipe 202, depending on the angle of incidence, and therefore, change the amount of radiant energy transmitted to heat flux sensing component 300. For example, FIG. 4B discloses an exemplary planar angular sensitivity corrector 204 having little or no shaping, (e.g., the input end of light pipe 202 is substantially planar) protruding into a process chamber through process chamber wall 404. A relationship is also illustrated wherein the energy absorption amount (sensitivity) vs. approach angle (at 408) for this corrector is graphed at 408.

FIGS. 4C, 4D and 4E disclose other exemplary shapes of the input end of light pipe 202 that form angular sensitivity correctors 204 with the relevant graphs of sensitivity 408. These exemplary shapes may increase energy absorption within some angles of incidence for radiation impinging on the input end of light pipe 202. FIG. 4C discloses a conical shape of the light pipe input end. In this example, the greatest sensitivity to energy from source 400 is along the axis of the light pipe, but the drop-off of sensitivity at off-normal angles is much less. FIG. 4D discloses a convexly curved shape of the input end of the light pipe, having approximately constant sensitivity with all angles of incidence. FIG. 4E discloses a concavely curved shape of the input end of the light pipe, having a greater sensitivity at angles off the axis of the light pipe.

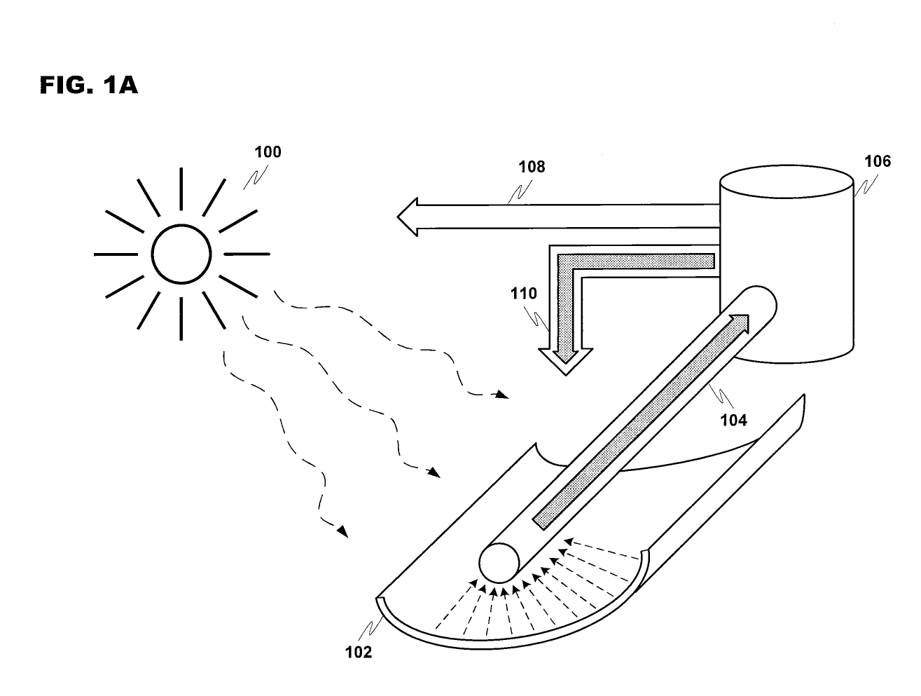

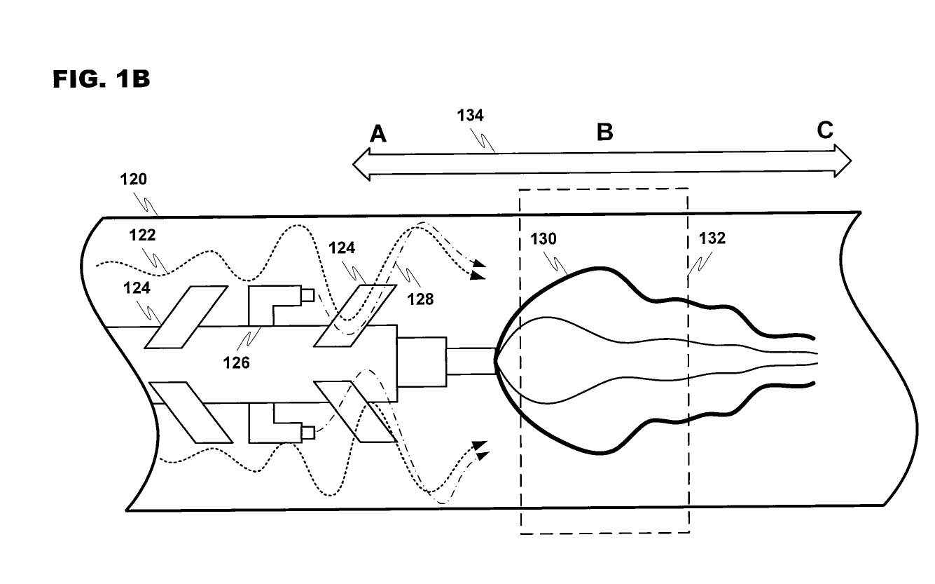

The selection of a particular angular sensitivity corrector 204 may depend on the use to which sensor device 200 is applied. For example, the angular sensitivity corrector 204 disclosed with respect to FIG. 4D may be more appropriate for large field process monitoring, such as in the example of a solar plant disclosed in FIG. 1A. On the other hand, the angular sensitivity corrector 204 disclosed in FIG. 4C may be more appropriate for narrow field sensing, such as determining an ignition location with respect to a stoichiometrically lean engine such as previously disclosed with respect to the example process of FIG. 1B.

The index of refraction of the light pipe material may also influence the functional relationship between angle of incidence and sensitivity. Consequently the shape of the angular sensitivity corrector surface for a particular functional relationship between sensitivity and angle of incidence may be different for alternative light pipe materials.

With respect to angular sensitivity corrector implementation, FIGS. 4F-4G further clarify that the angular sensitivity corrector 204 is not limited to a shape in the actual input end of light pipe 202. Instead, angular sensitivity corrector 204 may be a separate component affixed to light pipe 202 as shown in FIG. 4F-4G. In FIG. 4F, coupling 410 may connect angular sensitivity corrector 204 to light pipe 202 so that the low-light loss properties of light pipe 202 may be maintained. In this way, a more generalized sensor device 200 may be envisioned, wherein the device may be customized for use in a process by employing a particular angular sensitivity corrector 204 to the input end. Similarly, FIG. 4G shows angular sensitivity corrector 204 limited to a lens 412 affixed to the input end of light pipe 202. The configuration of the angular sensitivity corrector 204 may be determined based on the process conditions, device cost, etc. For example, if the process is particularly harsh or caustic, it may be beneficial to use the configuration of FIG. 4F so that coupling 410 is not exposed to the process environment.

### IV. Heat Flux Sensing Component

Now referring to FIG. 5, an exemplary heat flux sensing component 300 in accordance with various embodiments of the present invention is disclosed. Heat flux sensing component 300 may be contained within second housing component 208 (e.g., in an embodiment of the present invention where a multicomponent housing is used). Heat flux sensing component 300 may be held in second housing component 208 by adhesive bonding, mechanical attachment, frictional engagement, etc. providing that the device sensors are not obstructed.

More specifically, a detail view of an exemplary device usable in at least one embodiment of the present invention is shown, in part, with respect to FIG. 5. The exemplary device shown in FIG. 5 is a Heat Flux Microsensor (HFM). This type of sensor is a thermopile comprising multiple individual thermocouple sensor pairs connected in series. This multiplicity of sensors may measure a heat flux induced in measuring junctions with respect to a reference surface.

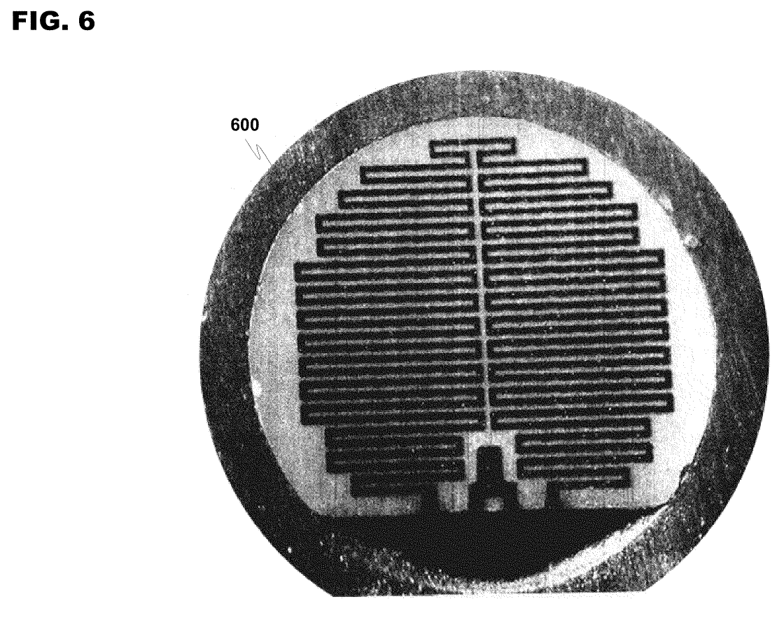

For the sake of explanation in the present disclosure an exemplary thermocouple pair is shown in FIG. 5 formed on substrate 500. Substrate 500 may be manufactured from a material having high thermal conductivity and high electrical resistivity such as Aluminum Nitride (AlN). Initially, layers 502 and 504 may be deposited on substrate 500. These layers may be made of a material that is an electrical and thermal insulator, such as Silicon Monoxide (SiO). Then, layers 501 and 503 of a first thermoelectric material such as platinum may be deposited, partially overlapping the substrate 500 and the layers 502 and 504. Finally, layers 505 and 507 of a second thermoelectric material such as nickel may be deposited, forming a thermocouple pair with a first junction directly on the substrate and a second junction thermally insulated from the substrate. The first junction may be deemed a “reference junction” and the second may be deemed a “measuring junction.” A temperature difference indicative of heat flux may then be determined from the different temperatures measured by the thermocouples. As stated above, the disclosed thermocouple pair is shown only for the sake of explanation in the present disclosure. In an exemplary HFM there may be three hundred (300) pairs of thermocouples deposited in a series combination. These thermocouples may form a sensing surface on the HFM, an example of which is shown is shown in image 600 disclosed in FIG. 6. The serial thermocouple pairs on the HFM sensing surface may measure heat flux with linearity and quick response time in a compact device usable in many applications.

As previously disclosed, heat flux sensing component 300 (e.g. an HFM) may measure a heat flux by employing a high emissivity material 302 that is thermally coupled to the sensing surface of the heat flux measuring component in at least one embodiment of the present invention. Now describing how high emissivity material 302 may function in accordance with at least one embodiment of the present invention, when radiant energy is emitted by the monitored process, it may be collected by angular sensitivity corrector 204. Light pipe 202 may then efficiently transmit the collected radiant energy to its output end. As set forth above, the output end of light pipe 202 may be located adjacent to the sensing surface of heat flux sensing component 300. The conveyed process radiant energy may then be directed across the gap between the output end of light pipe 202 and the sensing surface of heat flux sensing component 300 into the high emissivity material, which then converts the radiant energy to heat. Heat flux sensing component 300 may then read the difference in temperatures across its thermocouple pairs (e.g., the temperature of material 300 vs. a reference temperature), and deliver heat flux information to a process controller for controlling conditions in a monitored process.

The present invention, in various embodiments, may include temperature control components (e.g., 210 and 306) in order to isolate the heat flux sensing component from any ambient temperature influences that might affect accuracy. However, the information from heat flux sensing component 300 may also be corrected for component temperature. In the case of an HFM, the device may be calibrated for use as a heat flux standard or process controller. The exemplary HFM described in FIG. 5-6 may further include another thermocouple to monitor the temperature of substrate 500. In this way, a process controller may account for the temperature of heat flux sensing component 300 to adjust the process heat flux information accordingly.

Accordingly, it will be apparent to persons skilled in the relevant art that various changes in form and detail can be made therein without departing from the spirit and scope of the invention. The breadth and scope of the present invention should not be limited by any of the above-described exemplary embodiments, but should be defined only in accordance with the following claims and their equivalents.

1. A device, comprising:
a heat flux sensing component;
a light conveyance component including at least an output end and an input end, the output end being arranged adjacent to the heat flux sensing component and being separated from the heat flux sensing component by a gap; and
an angular sensitivity corrector coupled to the input end, the angular sensitivity corrector having a shape configured to adjust the sensitivity of the heat flux sensing component as a function of angle.

2. The device of claim 1, wherein the heat flux sensing component includes a sensing surface, the sensing surface being thermally coupled to a high emissivity material.

3. The device of claim 2, wherein the heat flux sensing component is configured to sense a difference in a temperature induced in the high emissivity material by the light conveyed by the light conveyance component as compared to a reference temperature.

4. The device of claim 1, wherein the light conveyance component is a substantially cylindrical light pipe comprising low light loss material.

5. The device of claim 4, wherein the light pipe is configured to convey light from the angular sensitivity corrector to the heat flux sensing component.

6. The device of claim 1, wherein the light conveyance component comprises fiber optics.

7. The device of claim 6, wherein the light conveyance device comprises a plurality of optical fibers bundled together.

8. (canceled)

9. The device of claim 1, wherein the shape is formed in the input end of the light conveyance component.

10. The device of claim 9, wherein the shape formed in the input end is at least one of flat, conical, curved concave or curved convex.

11. The device of claim 1, wherein the angular sensitivity corrector is a separate component affixed to the input end of the light conveyance component.

12. The device of claim 1, wherein the light conveyance component and the heat flux sensing component are coupled to a device housing.

13. The device of claim 12, wherein the device housing comprises at least a first housing component coupled to the light conveyance component and a second housing component coupled to the heat flux sensing component.

14. The device of claim 13, where the gap between the output end of the light conveyance component and the heat flux sensing component is formed by coupling the first housing component to the second housing component.

15-16. (canceled)

17. The device of claim 1, wherein the gap is evacuated.

18. The device of claim 1, wherein the gap is filled by at least one of air or an inert gas.

19. The device of claim 1, wherein the shape is configured to adjust the sensitivity of the heat flux sensing component by adjusting the angular distribution of light absorbed by the input end of the light conveyance component.
